(19) United States
(12) Patent Application Publication
(10) Pub. No.: US 2011/0131547 A1
(43) Pub. Date: Jun. 2, 2011

(54) METHOD AND SYSTEM DEFINING AND INTERCHANGING DIAGRAMS OF GRAPHICAL MODELING LANGUAGES

(75) Inventor: Maged E. ELAASAR, Kanata (CA)

(73) Assignee: International Business Machines Corporation, Armonk, NY (US)

(21) Appl. No.: 12/628,630

(22) Filed: Dec. 1, 2009

(51) Int. Cl. G06F 9/44

(52) U.S. Cl. 717/105

(57) ABSTRACT

Computer based method, apparatus and system provides diagram interchange and diagram definition in graphical modeling languages. The invention system models diagram definition for a given diagram type and models diagram interchange. The diagram definition defines valid diagram syntax for diagrams of the given diagram type. The diagram interchange is modeled in a manner that provides common diagram persistence and interchange building blocks. The interchange building blocks are usable by graphical modeling languages to persist and interchange their diagram syntax. The invention separates diagram syntax of the building blocks from the rules (diagram definition) that govern valid composition of the building blocks.

### BACKGROUND

As model-driven development (MDD) in computer software is becoming more fashionable, the need for interchanging models of arbitrary modeling languages is growing. The Object Management Group (OMG) defines various standards to push the MDD vision forward. One such standard is the Meta Object Facility (MOF), which is used to define the abstract syntax of arbitrary modeling languages. Another standard is the XML Metadata Interchange (XMI), which is used to interchange MOF-based models of computer programs/software. Using these standards, MOF-based tools can define domain-specific modeling languages and support for the interchange of their actual models.

However, this nice story stops at the point where there is a need to interchange the diagrams of graphic modeling languages. Users of those languages, like UML, SysML and BPMN, expect to interchange diagrams of program design (or so called “models”) between different tools in a non-proprietary form. One answer to this problem is OMG's Diagram Interchange (DI) standard, which defines one XMI format for interchanging arbitrary diagrams of software programs and design (models). However, the DI standard itself is not precise enough to enable consistent interchange of diagrams between different tools. To gain interoperability, tool vendors need extra guidelines for each specific diagram type. These guidelines (called ‘nesting’ rules in the DI specification) define how that particular diagram syntax is rendered in the DI metamodel as a structure of nested diagram syntax elements. The problem here is that those diagram defining guidelines are informal and hence cannot be used to automatically create and validate diagrams. Other industry leading diagramming toolkits, such as Eclipse's Graphical Modeling Framework (GMF), also provide common diagram interchange building blocks but stop short of giving a way to specify the arrangement of these blocks that define valid diagram syntaxes.

One way of doing this is to extend the building blocks in DI for every diagram type using MOF's inheritance and redefinition semantics, creating a diagram-specific metamodel and interchange schema. This has negative consequences in terms of the difficulty of using general purpose diagramming tools for creating/validating those diagrams and the inability to create hybrid cross-domain diagrams, which is a growing trend in the industry.

Another problem with OMG's DI standard is over commitment to ideas that may not apply in general or may lead to inadequacies or inefficiencies. For example, DI makes an assumption that all diagram elements are laid out on a grid and hence have bounds (position and a size) as persistable layout constraints. This ignores the fact that diagrams may use a variety of non-grid layout algorithms that have their own notions of layout constraints. Another example is the definition of graphical primitives as DI building blocks introducing unnecessary coupling between diagram interchange and rendering and suggesting that DI blocks have to correspond one to one to their rendering counterparts.

These problems with OMG's DI standard contribute and explain the lack of wide-spread industry adoption of the specification to date. What is needed is a common diagram interchange solution that is flexible enough to be used consistently for various graphical modeling languages and extensible enough to accommodate the specific needs of such languages. The solution should also allow for the definition of valid diagrams so that tools can leverage this definition to automatically create and validate diagrams.

### SUMMARY

The present invention proposes a new diagram interchange and definition solution for graphical modeling languages. More specifically, it proposes two new MOF-based and XMI-interchanged domain-specific systems called diagram interchange (DI) and diagram definition (DD).

The goal of the invention DI language/system is to provide common diagram persistence and interchange building blocks that can be used by graphical languages (such as UML, SysML and BPMN) to persist and interchange their diagram syntax. The new DI language also addresses various concerns that tool vendors have when implementing modeling diagrams. The first concern is complexity and is dealt with by defining a small but extensible core of general purpose building blocks (e.g., graphing elements). Another way that DI deals with complexity is to clearly separate business data from diagram data, or more idiomatically to separate the model from the view. The second concern is maintainability and is dealt with through the separation between the syntax of the DI blocks and the rules that govern their valid composition (provided by DD). The last concern is scalability and is dealt with by eliminating redundancy and favoring efficient design alternatives.

The goal of the invention DD language/system is to provide a way to describe the valid composition of DI blocks/graph elements for a given diagram type. The DD language is used to create diagram definition libraries that are referenced by diagrams and define their valid syntaxes. In a way, DD instances can be thought of as schemas of DI instances. However, this referencing versus being instances of DD schemas is what leaves DI to be small and resilient to changes to the specific diagram syntax. This also increases the flexibility as it allows diagram definitions to not be restricted by MOF/schema metamodel semantics. In addition, allowing DI to reference DD as a definition facilitates the extension of diagrams by tool vendors and users without worrying about breaking interchange. Finally, it allows for the development of diagramming toolkits that use DD libraries to generate modeling tools capable of creating and validating diagrams.

In a preferred embodiment, the invention method, system, apparatus comprise: a diagram definition module and a diagram interchange member. The diagram definition module models diagram definition of a given diagram type including defining valid diagram syntax for diagrams of the given diagram type. The diagram interchange member is configured to model diagram interchange in a manner (i) providing common diagram persistence and (ii) enabling interchange of diagram syntax. The diagram definition module and the diagram interchange member separate (a) diagram syntax and (b) rules that govern valid composition of diagram syntax in a certain diagram type.

In one embodiment, the diagram interchange member further defines a set of general purpose graphing elements usable by graphical modeling languages to persist and interchange their diagram syntax. The diagram definition module and the diagram interchange member separate diagram syntax of the graphing elements from the rules that govern valid composition of the graphing elements for the given diagram type, provided by the diagram definition module.

In some embodiments, the diagram interchange member further separates abstract syntax of a subject model from diagram data representing view of the subject model.

In embodiments, the diagram definition module further generates diagram definition libraries that are referenced by respective diagrams and define corresponding valid syntaxes of the respective diagrams. The generated diagram definition libraries enable the diagram interchange member to be resilient to changes to specific diagram syntax. The diagram definition libraries may enable generation of a modeling tool capable of creating and/or validation diagrams.

The diagram definition module may further allow diagram definitions to not be restricted by metamodel sematics of model abstract syntax of a graphical modeling language.

In some embodiments, the modeled diagram interchange is allowed to reference diagram definition modeled by the diagram definition module.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of the relationship between the metamodels of the present invention Diagram Interchange (DI) Member, Diagram Definition (DD) module and a domain's abstract-syntax.

FIG. 2 is a schematic view of the metamodel or definitions of the invention Diagram Interchange (DI) member system in one embodiment.

FIG. 3 is a schematic illustration of various points of a connector in one embodiment of the present invention.

FIG. 4 is a schematic view of the metamodel or definitions of the invention Diagram Definition (DD) system in one embodiment.

FIGS. 5a and 5b are schematic and block views, respectively, of a computer network and computer node in the network in which embodiments of the invention are deployed.

### DETAILED DESCRIPTION

A description of example embodiments of the invention follows.

The teachings of all patents, published applications and references cited herein are incorporated by reference in their entirety.

Diagram Interchange (DI)

Overview

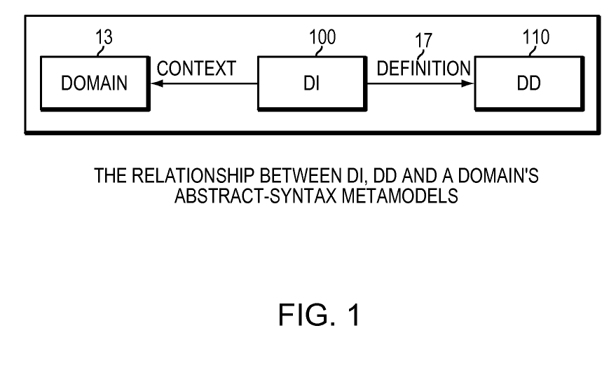

The goal of the invention DI language or system 100 (FIG. 1) is to provide a common way for MOF-based graphical domains (such as UML, SysML and BPMN) to define how their diagrams get persisted and interchanged. Having a common persistence model saves time and effort by not having to define it again for every domain. It also increases the consistency between possibly unrelated domains, which could facilitate future integration plans. Also, having a common interchange format benefits tool interoperability, which is an ever increasing demand by end users. That is why the invention DI language/system itself is defined with a MOF-based metamodel and hence its instances are serialized and interchanged with XMI.

Furthermore, a lot of the design decisions that characterize invention DI system 100 are motivated and influenced by experiences gained by working with similar technologies in the industry. Some of the major concerns in the industry in this area are the complexity, maintainability and scalability of diagrams of working models.

With regards to complexity concern, there are two major principles driving the design of DI member 100 (FIG. 1). The first one is having a simple yet solid core, while allowing for variability using extensions. Obviously, there is no single diagram definition that suits the requirements of all possible domains and tools. However, it is certainly possible to define a minimal core that captures the main design pattern and make it extensible to address more specific requirements. Some typical extension mechanisms for metamodels include inheritance and redefinition. However, if not done very carefully (which is often the case), these extensions can easily lead to non-conforming extensions creeping in that would hurt the interchange and break the potential generality of diagramming tools. In addition, this would cause every domain or tool to have its own extended diagram metamodel and consequently XMI schema, hindering reuse and interchange. For those reasons, the DI 100 metamodel is kept closed for extension by inheritance. Instead, the metamodel focuses on defining a core design pattern for diagram persistence that is minimally constrained and allows for adding domain 13 or tool specific extensions and/or constraints by referencing instances of another language module or system called Diagram Definition 110 (discussed later), as shown in FIG. 1.

The second principle of managing complexity is the separation between the business data and its diagram data, or more idiomatically between the model and its view. The business data of a given domain 13 is represented by its abstract syntax metamodel (i.e., the model's abstract syntax), where the diagram data (view of the model) needs to be captured in a separate metamodel (DI member 100) that references the former (abstract syntax or generally domain 13) as its context, as shown in FIG. 1. There are several advantages to this design including: the ability of both metamodels 13, 100 to evolve independently, the ability of a domain 13 element to have multiple alternate notations, the ability of a domain 13 element to be depicted more than once using the same notation and the ability of a notation to be defined using multiple diagram elements. This flexibility leads to more efficient and less bloated metamodel design for both the domain 13 and its diagram interchange.

Regarding the maintainability concern, the fact that the DI metamodel 100 is small and closed coupled with the built in separation of concern between the diagram interchange and its definition imply that the diagram interchange schema is less susceptible to change. This allows, for example, small extensions to be done to the diagram definition without affecting the diagram interchange, which can dramatically reduce the maintenance cost for tools. It also allows several unrelated extensions to be made without affecting their ability to coexist again reducing maintenance costs.

As for the scalability concern, the metamodel design focuses on eliminating redundancy as well as opting for alternatives that have more potential to scale better in realistic user setting. The scalability dimensions of importance here are memory footprint and change deltas. The details of the metamodel are given next and wherever alternatives exist, a justification for the chosen alternative is given.

Metamodel Description

View Hierarchy

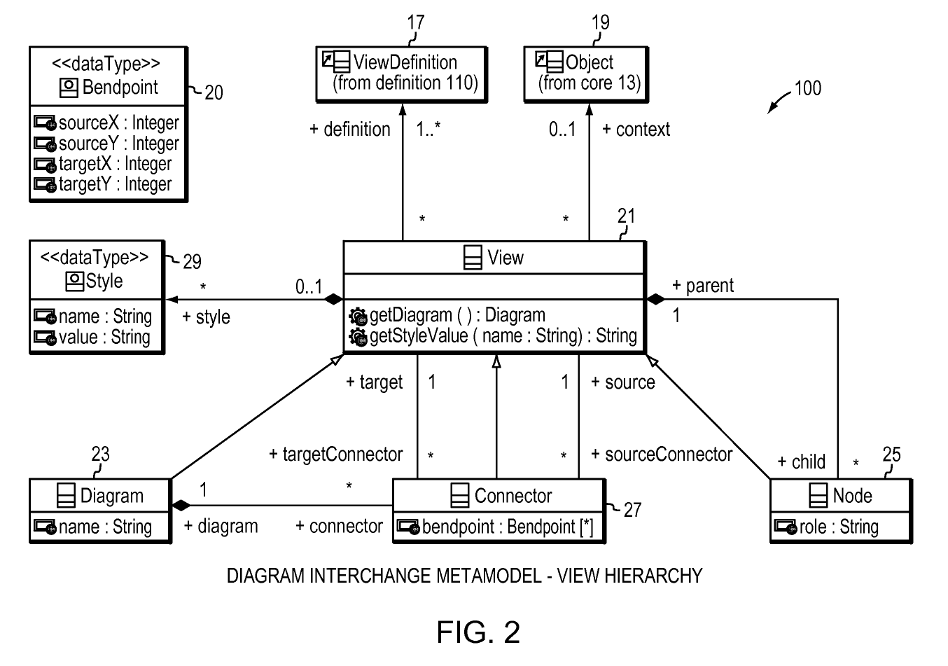

Turning to FIG. 2, the underlying pattern of the DI system 100 metamodel is based on graph theory. The basic abstraction in DI 100 is called a View 21, which corresponds to an attributed graph element. A view 21 owns a collection of name/value pairs representing its appearance attributes or styles. A View 21 is further specialized into several kinds that correspond to the different components of a graph. One kind of view is Diagram 23, corresponding to the graph itself, which is the containment root for all other views in the diagram. The other kinds are Node 25 and Connector 27. A Node 25 corresponds to a graph node and represents a child view that is contained by another view 21. A Connector 27 corresponds to a graph connector and represents a relationship between two views 21 (a source and a target). A view 21 hierarchy in one embodiment of the invention DI system 100 is shown in FIG. 2.

As mentioned in the previous section, the DI 100 metamodel is related to a domain 13 metamodel and to the DD 110 metamodel. The relationship to a domain 13 metamodel is manifested in the view 21 having an optional reference to MOF-based context object 19. When a view 21 has a reference to a context object 19 it is said to “visualize” this object. The relationship to the DD 110 metamodel is manifested in the view 21 having references to one or more view definitions 17. A view definition 17 classifies a view 21, defines its proper form and specifies rules for its validation. The first view definition 17 is the main definition that characterizes the view 21. The other optional view definitions 17 can be added by domain 13 extensions and/or tool implementations to extend the definition of the view 21.

An example embodiment (metamodel definitions) of the invention Diagram Interchange 100 is as follows.

Class Descriptions

View

A view 21 is the main abstraction in the DI system 100 metamodel. It is also the building block of a diagram of a subject model. A view 21 represents a unit of diagrammatic notation. A view 21 may be purely notational, in which case it coveys information that is not in any other model. A view 21 may also represent, by itself or with other views, the graphical notation of a context object 19 from a MOF-based domain model. View 21 is an abstract metaclass that is further subclassed into three concrete kinds: Diagram 23, Node 25 and Connector 27.

In addition to referencing a context object 19, a view 21 contains a collection of styles 29 (name/value pairs) representing its appearance properties (e.g. colors, line attributes, layout constraints . . . etc). A view 21 also contains a collection of nested child views that add to its notation. A view 21 also has two collections of references to source and target connectors. All these features give a view 21 the flexibility to meet the syntactical requirement of a large set of domains 13, while still conforming to a common design pattern.

However, for a particular view 21 instance, there must be a definition of its expected valid syntax. That is why a view 21 references one or more view definitions 17 that classify the view 21 and specify its valid syntax. The first definition 17 is the main one that defines the view 21. The other optional definitions 17 allow for extending the valid syntax for domain 13 and/or tool specific purposes. The conformance algorithm of a view 21 to its view definitions 17 is given as follows (for more details about a view definition 17, see the below description of Diagram Definition 110):

A view's context object 19 has to conform to the context type specified by all its view definitions 17 together.

Each style 29 owned by a view 21 has to correspond to exactly one style definition contained by one of the view's definitions 17. The correspondence is achieved when the name of a style 29 matches the name of a style definition. Also the value of a style 29 has to conform to the primitive type specified in its style definition.

Each nested child view 21 has to correspond to exactly one child definition contained by one of the view's definitions 17. The correspondence is achieved when the role of a child view matches the name of a child definition. The number of child views playing this role has to be compatible with the multiplicity specified by that child definition.

All constraints contained by all view definitions 17 referenced by a view 21 have to be satisfied together on the view.

Generalizations

None

Attributes

definition: ViewDefinition [1..*]

References a list of one or more references to view definitions 17 that define the valid syntax of a view 21. At least one definition 17 is required but other definitions are possible to allow domains 13 and/or tools to extend the valid syntax of a view 21.

context: Object [0..1]

References an optional MOF-based object representing the context of the view 21.

child: Node [0..1*]

Contains a list of (nested) child nodes 25. The opposite end is Node::parent. The association defines the composite pattern for views 21.

sourceConnector: Connector [0..*]

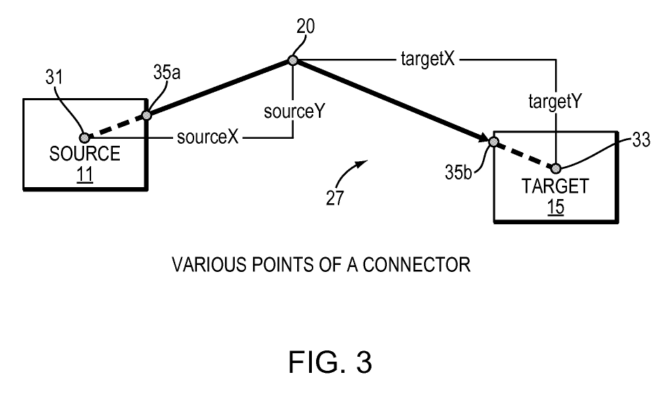

References a list of outgoing connectors 27 from the view 21. A source connector represents a relationship, in which the view 21 is playing the source role (such as source view 11 in FIG. 3). The opposite end is Connector::source.

targetConnector: Connector [0..*]

References a list of incoming connectors 27 to the view 21. A target connector represents a relationship, in which the view 21 is playing the target role (such as target view 15 in FIG. 3). The opposite end is Connector::target.

styles: Style [0..*]

Contains a collection of styles 29 (name/value pairs) providing override values for the appearance properties of the view 21.

Constraints

A view 21 cannot have more than one style instance with the same name.
A view 21 has to conform to all its view definitions 17.

Operations

The query getDiagram( ) returns the view's diagram by walking the view's containment chain up to a diagram.
The query getStyleValue(name: String) gets the value of the style.

Diagram

A diagram 23 is a special kind of view 21 that has a name and designates the root of containment for all views in one diagram. A diagram 23 directly contains all top level nodes 25, through the inherited ‘child’ association. It also directly contains all connectors 27 in the same diagram regardless of the nesting level of their source and target views 11, 15. This simplifies connector containment as it does not need to change in response to re-connections to different sources 11 or targets 15.

The topic of how diagrams 23 themselves are contained is a variation point for every domain 13 and/or tool. Typical options are (other options or a combination of those options are also possible):

as a root of a separate diagram resource,

as another root in a domain model resource,

in a diagram feature defined by a container domain element,

in a diagram feature defined by a context domain element.

Generalizations

### View

Attributes

name: String [1..1]

The name of the diagram 23.

connector: Connector [0..*]

Contains a list of connectors 27 in the diagram 23. Each connector's source and target views 11, 15 have to be nested in the same diagram 23.

Constraints

A diagram 23 can only be defined by DiagramDefinitions.

Node

A node 25 is a special kind of view 21 that can be nested (playing a child role) in some other view. It also represents a bounded area in the diagram that can be laid out (positioned and/or sized). The order of a node 25 in its parent's child collection may or may not have an impact of how the node gets laid out. Nodes 25 can represent notational idioms or play notational roles that are described in various graphical domains 13. For example, they can represent “shapes” on diagrams, “compartments” on shapes, “labels” on connectors, “list item” in lists, “nodes” in trees . . . etc.

Generalizations

### View

Attributes

role: String [1..1]

The role played by this node 25 as a child in its parent.

parent: View [1..1]

References the node's parent view 21 that contains this node 25.

Constraints

A node 25 can only be defined by NodeDefinitions.
The node's role must correspond to the name of exactly one of the child definitions contained by the view 17 definitions defining the node's parent view 21.

Connector

A connector 27 is a kind of view 21 that connects two other views: a source view 11 and a target view 15. A connector 27 is rendered as a line going from the source view 11 to the target view 15 through respective attachment points 35a, b. The line may be divided into segments by specifying bend points 20 along its route. Bend points 20 constrain the routing by forcing the connector's line to pass through them. A connector 27 may own a collection of label nodes, through its inherited ‘child’ property. Labels are laid out relative to a connector's line.

Generalizations

### View

Attributes

bendpoint: Bendpoint [0..*]

Contains a list of bendpoints 20 for the connector 27. Each bendpoint 20 specifies an offset from the connector's source and target anchoring point 31, 33.

source: View [1..1]

References the connector's source view 11.

target: View [1..1]

References the connector's target view 15.

diagram: Diagram[1..1]

References the connector's diagram 23 that owns the connector 27.

Constraints

A connector 27 can only be defined by ConnectorDefinitions.
The connector's source view 11 has to be nested in the same diagram as the connector 27.
The connector's target view 15 has to be nested in the same diagram as the connector 27.
A connector 27 cannot reference itself as a source or a target view.

Bendpoint

A bend point 20 is a datatype, which represents a point that a connector 27 has to pass through in its route. A bend point 20 is described by two offsets from the connector's source and target anchor points 31,33, as shown in FIG. 3. Describing a bendpoint 20 this way preserves its relative position when the connector's source 11 and/or target 15 change bounds.

Generalizations

### None

Attributes

sourceX: Integer [1..1]

The bendpoint's offset from the source anchor 31 along the x-axis.

sourceY: Integer [1..1]

The bendpoint's offset from the source anchor 31 along the y-axis.

targetX: Integer [1..1]

The bendpoint's offset from the target anchor 33 along the x-axis.

targetY: Integer [1..1]

The bendpoint's offset from the target anchor 33 along the y-axis.

Constraints

### None

Style

A style 29 is a datatype consisting of a string name/value pair. It represents an appearance property for a view 21 such as colors, line styles, layout constraints, drawing options . . . etc. The set of possible styles 29 for a given view 21 is given by the view's definition 17. Each style 29 is defined by its name, type and default value. Instances of the style datatype represent a particular instance of a style 29 with a given value.

Although the style's type may be an arbitrary datatype, the style's value is always encoded as a string. For example if the style's type is a boolean, possible values would be the string literal “true” or “false”.

Generalizations

### None

Attributes

name: String [1..1]

The style's 29 name string.

value: String [1..1]

The style's 29 value encoded as a string.

Constraints

The style's 29 string value is compatible with the style's defined type.

Diagram Definition (DD)

Overview

The previous section discussed invention DI module, a language or system 100 to create and persist diagrams with. DI system 100 defines a schema for diagrams that is both flexible and domain 13 independent. However, in order to interchange diagrams between domain specific tools, there must be a domain specific definition describing valid diagrams of that domain 13.

There are two approaches to having a domain specific diagram definition. One approach is to extend DI 100 through MOF inheritance or package merge semantics to end up with a domain-specific DI (diagram interchange). Although this approach benefits from having one diagram metamodel to use for each domain 13, it suffers from several practical drawbacks. First, it makes it more difficult to create or leverage general-purpose diagramming toolkits as it forces dealing with different possibly inconsistent diagram metamodels. Second, it reduces the potential of defining cross-domain hybrid diagrams which could undermine future integration efforts between domains 13. Third, it forces the resulting metamodel to have some parallel to the domain's abstract syntax metamodel resulting in a larger interchange schema that is also more susceptible to changes to the abstract syntax metamodel, increasing the maintenance cost.

The other approach to having a domain-specific diagram definition is to define it with a separate Diagram Definition (DD) language/system 110 of the present invention. The metamodel for DD module 110 is used to create M1 instances (model libraries representing diagram definitions) that are referenced by diagrams (DI system 100 instances). This architecture, which is adopted here, allows for several advantages. First, having a domain-independent DI system 100 means the interchange schema remains small and more stable (unaffected by changes to the abstract syntax of domains 13), reducing maintenance costs. Second, having domain independent DI/DD metamodels 100, 110 allows for creating and/or leveraging general-purpose diagramming toolkits to define DSL modeling tools with, compressing time to market. Third, having consistent DI/DD metamodels 100, 110 across domains 13 eases the integration effort between specifications and/or tools, creating synergies and increasing business value. Fourth, separating DI system 100 and DD system 110 allows better separation of concerns. While DI 100 is used to create and persist diagrams, DD 110 is used to define the valid diagram syntax. This increases the flexibility as it allows diagram definitions to not be restricted by MOF/schema metamodel semantics. The relationship between these various metamodels 13, 100, 110 is shown in FIG. 1.

The main use case for associating diagrams with their definitions, expressed as DD 110 instances, is diagram syntax validation. The DD system 110 metamodel defines and constrains various aspects of diagrams including composition rules, semantic references, and allowed styles. The other possible use cases for diagram definition are to help automate diagram creation with proper syntax and to help query and identify various parts of diagrams in a consistent way, which helps the generality of diagramming tools.

DD 110 instances are called diagram definition libraries (DD libraries 110, generally) as they are defined at the M1 level. The DD library for each standard domain 13 becomes part of the specification of that domain 13. Such a library is published with the specification and implemented by tool vendors. Hence, the standard DD libraries referenced from user diagrams do not need to be interchanged. On the other hand, if user diagrams reference non-standard (domain extension or tool specific) DD libraries and wish to interchange with other tools, those definition libraries need to also be available and recognized by those tools; otherwise, those definitions and their data would be ignored. In any case, the diagram data is still readable as it conforms to the same non-changing DI 100 schema.

Metamodel Description

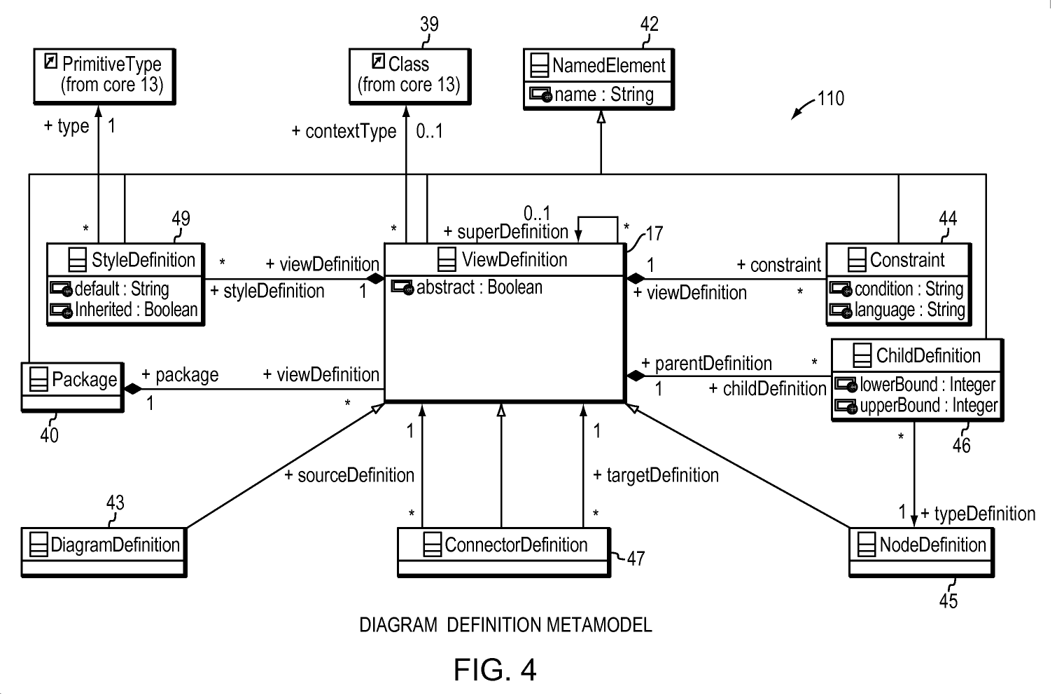

The DD system 110 metamodel, shown in FIG. 4, provides definitions and constraints for the artifacts in the DI 100 metamodel. That is why there is an obvious resemblance between the designs of both metamodels (invention systems) 100, 110. At the core of the DD 110 metamodel, there is the concept of a view definition 17. A view definition 17 specifies various aspects of how a view 21 should conform including the type and multiplicity of child views, the definition of the allowed styles 29, the type of the allowed context reference and other arbitrary constraints. A view definition 17 is further subclassed by node definition 45, connector definition 47 and diagram definition to 43 match the different kinds of views in DI System 100. View definitions 17 are owned by a hierarchy of nested packages 40.

An example embodiment (metamodel and definitions) of the invention Diagram Definition Module 110 is as follows with reference to FIG. 4.

Class Descriptions

NamedElement

A named element 42 is an element with a unique name in its containment collection. NamedElement 42 is an abstract metaclass.

Generalizations

### None

Attributes

name: String [1.1]

The name of the named element 42.

Constraints

The name of the element has to be different from the names of its siblings in the same containment collection.

Package

A package 40 is the root of containment in a DD model library 110. It is a named element 42 representing a namespace for all the DD view definitions 17 contained inside it.

Generalizations

### NamedElement

Attributes

viewDefinition: ViewDefinition [0..*]

Contains a list of all view definitions 17 in the DD instance library 110.

Constraints

### None

ViewDefinition

A view definition 17 is the main abstraction in the DD metamodel 110. It is also the building block of a DD library 110. A view definition 17 specifies the syntax rules for a view 21 in DI 110. Various rules can be specified including the type and multiplicity of child views that can be composed in a view 21, the styles 29 that can annotate a view 21, the type of the object 19 that can be the context of a view 21, in addition to arbitrary constraints 44 on a view. A view definition 17 is abstract and is further subclassed by three concrete subclasses: diagram definition 43, node definition 45 and connector definition 47.

The allowed context type of a view 21 is specified by a reference to the allowed context metaclass 39 on the view definition 17. When no context type is specified, a view 21 cannot reference any context object 19. This is the case for purely notational views or views whose context is implied by other related views (e.g., by the parent view for nodes 25 or the source and target views 11, 15 for connectors 27). When the context type is specified, a view 21 must reference a context object 19 that conforms to (is instance of) this context type. For example, if a view definition 17 references the type UML State, views 21 conforming to this definition must reference a UML state object as a context.

The allowed styles 29 of a view 2l are specified by a collection of style definitions 49 owned by the view definition 17. A conforming view 21 can only be annotated by styles 29 that conform to those style definitions 49. The conformance here is established when a style 29 has the same name as well as a conforming value to one of the style definitions 49.

The allowed children of a view 21 are specified by a collection of child definitions 46 owned by the view definition 17. Each child definition 46 specifies the allowed multiplicity (lower and upper bound) as well as the allowed type of a child view. The type of a child definition 46 is always a node definition 45. A conforming view 21 owns children views that conform to those child definitions 46. Child conformance is established when the child view is defined by the child definition's 46 type (or one of its subtypes) and respect its multiplicity (the number of children views conforming to that child definition 46 complies with its multiplicity).

A view definition 17 can also specify arbitrary constraints 44 on a view 21. Each constraint 44 has boolean expressions, expressed in some query language, in the context of the corresponding view's metaclass. A constraint 44 can check any aspect of a view 21 including its context object 19, its style 29 values and its relationships to other views. A conforming view satisfies all the constraints 44 of its view definition 17.

In addition, view definitions 17 can be defined as abstract or concrete and can be organized into inheritance hierarchies. Abstract definitions 17 cannot be used to define views 21, while concrete definitions can be. To participate in an inheritance hierarchy, a view definition 17 references another definition 17 as its super definition. Only single inheritance is allowed for view definitions 17. The semantics of inheritance in this context is as follows:

A sub view definition inherits a reference to a context type from its super definition chain. However, a sub view definition can refine the inherited context by specifying its own reference to a type that is either the same as or a subtype of the inherited context type.

A sub view definition inherits the child definitions 46 of its super definition chain. A sub definition can also provide its own child definitions 46 that either add to or refine the inherited child definitions 46. If a new child definition 46 has the same name as one of the inherited child definition 46, it is a refinement; otherwise it is an addition. A refining child definition 46 specifies its own multiplicity and type, which is the same as or a subtype of the refined definition's type.

A sub view definition inherits the style definitions 49 of its super definition chain. A sub definition can also provide its own style definitions 49 that are additions to the inherited ones. New style definitions 49 must have different names than the inherited definitions.

A sub view definition inherits the constraints 44 of its super definition chain. A sub definition can also provide its own constraints 44 that are additions to the inherited ones. New constraints 44 must have different names than the inherited constraints.

Generalizations

### NamedElement

Attributes

abstract: Boolean [0..1]

A boolean value that specifies wether the view definition is abstract. The default is ‘false’ meaning non-abstract (or concrete).

package: Package [1..1]

References the package 40 that contains this view definition 17.

superDefinition: ViewDefinition [0..1]

References an optional super (more general) view definition 17 of this definition.

contextType: core::Class [0..1]

References an optional MOF-based metaclass 39 representing the context type of this view definition 17. Views 21 that conform to this view definition 17 would reference a context object 19 that is an instance of this metaclass 39.

childDefinition: NodeDefinition [0..*]

Contains a list of child definitions 46 of this view definition 17. Child definitions 46 define valid children views of views 21 conforming to this view definition 17.

styleDefinition: StyleDefinition [0..*]

Contains a list of style definitions 49 of this view definition 17. Style definitions 49 define valid styles 29 of views 21 conforming to this view definition.

constraint: Constraint [0..*]

Contains a list of constraints 44 of this view definition 17. These constraints must be satisfied by views 21 defined by this view definition 17.

Constraints

View definition 17 inheritance hierarchies must be directed and acyclic. A view definition 17 cannot be both a transitively super and transitively sub definition of the same definition 17.

A super definition must be an instance of the same metaclass as this definition. For example, a node definition 45 may only have other node definitions 45 as a super definition.

A view definition's context type must either be the same as or a subtype of an inherited context type.

DiagramDefinition

A diagram definition 43 is a concrete kind of view definition 17 that defines the syntax rules of DI diagrams 23.

Generalizations

### ViewDefinition

Attributes

### None

Constraints

The super definition of a diagram definition 43 must be of type diagram definition as well.

NodeDefinition

A node definition 45 is a concrete kind of view definition 17 that defines the syntax rules of DI nodes 25.

Generalizations

### ViewDefinition

Attributes

### None

Constraints

The super definition of a node definition 45 must be of type node definition as well.

ConnectorDefinition

A connector definition 47 is a concrete kind of view definition 17 that defines the syntax rules of DI connectors 27. A connector definition 47 references a source view definition and a target view definition. Those definitions define the valid source 11 and target 15 of a connector 27 that conforms to this connector definition 47.

Generalizations

### ViewDefinition

Attributes

### None

Associations

sourceDefinition: ViewDefinition [1..1]

References a view definition 17 that defines the valid source 11 of a connector 27 conforming to this connector definition 47.

targetDefinition: ViewDefinition [1..1]

References a view definition 17 that defines the valid target 15 of a connector 27 conforming to this connector definition 47.

Constraints

### None.

ChildDefinition

A child definition 46 specifies the conformance rules for child views 21 that are contained by other views 21. Child definitions 46 are owned by the view definitions 17 of those container views 21. In particular, a child definition 46 specifies a name, inherited from NamedElement 42, representing a role played by conforming child views. It also specifies the valid multiplicity and type definition of those child views 21.

Generalizations

### NamedElement

Attributes

lowerBound: Integer [0..1]

Is the lower multiplicity of child views 21 defined by this child definition 46.

upperBound: Integer [0..1]

Is the upper multiplicity of child views 21 defined by this child definition 46.

typeDefinition: NodeDefinition [1..1]

References a node definition 45 that defines the child view.

parentDefinition: ViewDefinition [1..1]

References a view definition 17 that contains this child definition 46.

Constraints

A child definition 46 must have a unique name within its containing view definition 17.

StyleDefinition

A style definition 49 is contained by a view definition 17. It specifies the conformance rules of a style 29 that can annotate views 21 that conform to that view definition 17. In particular, a style definition 49 specifies a name, which needs to match a style's 29 name to establish the correspondence between them. A style definition 49 also specifies the type that a style 29 value needs to conform to. This type is one of the primitive types (i.e. not structured type). A default value can also be specified.

Additionally, a style definition 49 specifies whether a style 29 is inherited or not. An inherited style allows views 21 that are not annotated themselves with this style to “inherit” the style 29 from the closest parent view that is annotated with this style in their parent chain. A view 21 is said to be annotated with a style 29 if it contains the style.

Generalizations

### None

Attributes

default: String [0..1]

Is an optional default value of the style 29.

inherited: Boolean[0..1]

Specifies whether the style 29 is inherited or not. The default is ‘false’, i.e. not inherited.

type: core::PrimitiveType[1..1]

References a MOF-based primitive type representing the type of this style 29.

viewDefinition: ViewDefinition [1..1]

References a view definition 17 that contains this style definition 49.

Constraints

The default value of the style 29 has to be a literal that is compatible with the style's type.

Constraint

A constraint 44 represents an arbitrary condition, expressed in some query language, that must be satisfied by views 21 conforming to the view definition 17 that contains this constraint 44. The context type of a constraint 44 corresponds to the view metaclass 39 implied by the view definition 17 that owns the constraint 44.

Generalizations

### NamedElement

Attributes

condition: String [1..1]

A condition that is specified in the context of a view metaclass 39 that corresponds to the view definition 17 that owns this constraint 44. For example, if the constraint 44 is owned by a node definition 45, the condition's context would be the metaclass Node 25 from DI 100.

language: String [0..1]

The query language used to specify the condition. It is optional with a default of ‘OCL’.

viewDefinition: ViewDefinition [1..1]

References a view of definition 17 that contains this constraint 44

Constraints

### None.

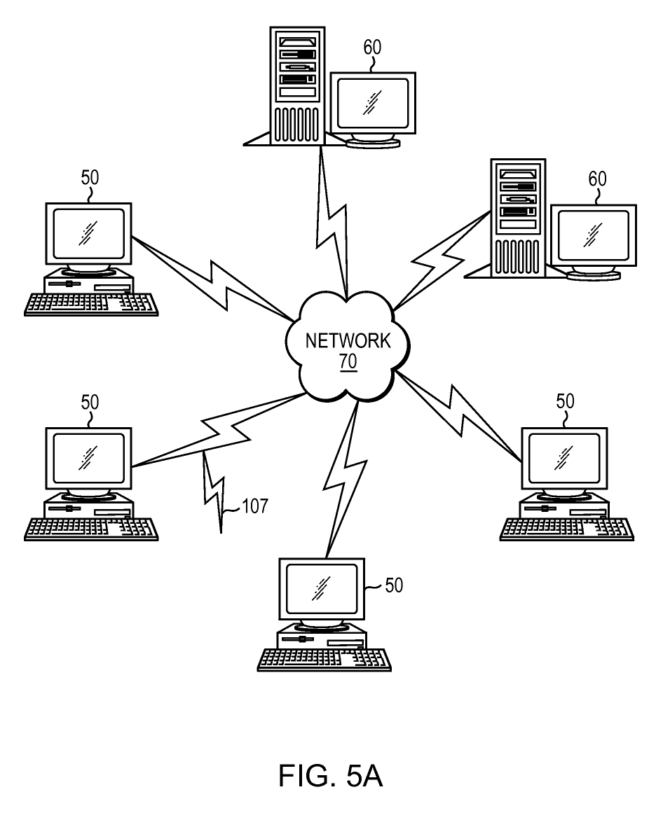

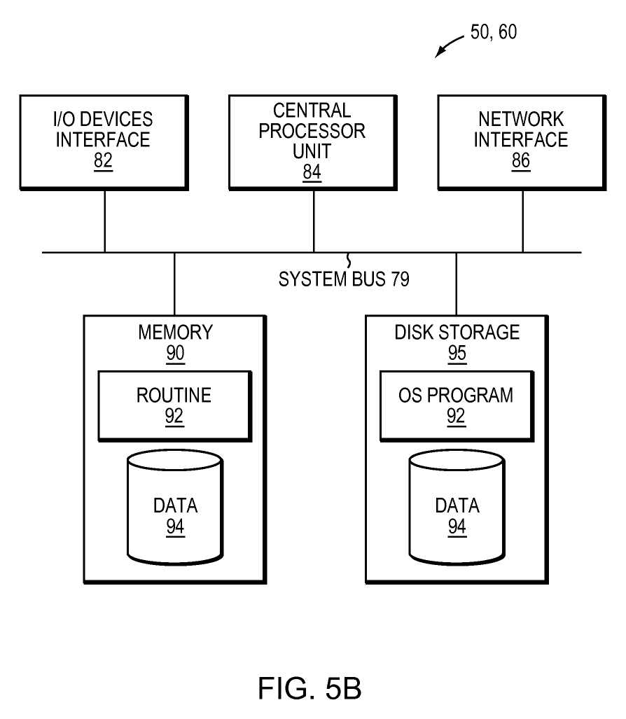

FIG. 5a illustrates a computer network or similar digital processing environment in which embodiments of the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 5b is a diagram of the internal structure of a computer (e.g., client processor/device 50 or server computers 60) in the computer system of FIG. 5a. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 5a). Memory 90 provides volatile storage for computer software instructions 92 and data 94 used to implement an embodiment of the present invention (e.g., Diagram Interchange System/Module 100, Diagram Definition System/Module 110 and supporting code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to non-limiting examples of the present invention Diagram Interchange 100 and Diagram Definition 110 as applied to UML (Unified Modeling Language) are the following code samples:

Sample Diagram Interchange (DI) Diagram for UML

```
<Diagram xmi:id=“1”>
    <definition mxi:type =
“dd:DiagramDefinition” href = “uml.definition#//ClassDiagram”/>
    <child mxi:id = “2”>
        <definition mxi:type = “dd:NodeDefinition” href =
“uml.definition#//Class”/>
        <element xmi:type = “uml:Class” href=“model.uml#//...”/>
        <child xmi:id = “3”>
            <definition mxi:type = “dd:NodeDefinition” href =
“uml.definition#//AttributeCompartment”/>
            <style key=“collapsed” value=“true”/>
            <style key=“ratio” value=“.25”/>
        </child>
        <child xmi:id = “4”>
            <definition mxi:type = “dd:NodeDefinition” href =
“uml.definition#//OperationCompartment”/>
            <style key=“showTitle” value=“true”/>
            <style key=“ratio” value=“.75”/>
        </child>
        <style key = “x” value = “100”/>
        <style key = “y” value = “200”/>
        <style key = “fillColor” value = “0x00FF000000”/>
    </child>
</Diagram>
```

Sample DI Style Sheet for UML

```
<StyleSheet xmi:id = “1”>
    <rule xmi:id = “2” condition = “self.element.oclAsType
(uml::Class)”>
        <type href = “di.core#//Node”/>
        <style key = “fillColor” value = “0x00FF000000”/>
    </rule>
    <rule xmi:id = “3” condition = “self.element.oclIsKindOf(uml::Class)
and self.element.oclAsType(uml::Class) .abstract”>
        <type href = “di.core#//Node”/>
        <style key = “fillColor” value = “0x0000FF0000”/>
    </rule>
</StyleSheet>
```

Sample Diagram Definition (DD) Instance for UML

```
abstract diagram UMLDiagram
{
    child shapes [0..*] : UMLShape;
}
diagram ClassDiagram extends UMLDiagram
{
}
abstract node UMLShape
{
    style x : Integer = 0;
    style y : Integer = 0;
    style fillColor : Integer = 0;
}
abstract node ClassifierShape extends UMLShape
{
    element : uml::Classifier;
    child attributeCompartment [1..1] : AttributeCompartment;
    child operationCompartment [1..1] : OperationCompartment;
}
node ClassShape extends ClassifierShape
{
    element : uml::Class;
}
abstract node UMLCompartment
{
    style collapsed : Boolean = false;
    style showTitle : Boolean = false;
    style ratio : Double = −1;
}
node AttributeCompartment extends UMLCompartment
{
}
node OperationCompartment extends UMLCompartment
{
}
```

Sample DD Instance for UML

```
abstract node UMLShape
{
    style x : Integer = 0;
    style y : Integer = 0;
    style fillColor : Integer = 0;
}
abstract node ClassifierShape extends UMLShape
{
    element : uml::Classifier;
    child attributeCompartment [1..1] : AttributeCompartment;
    child operationCompartment 1..1] : OperationCompartment;
}
node ClassShape extends ClassifierShape
{
    element : uml::Class;
}
abstract node UMLCompartment
{
    style collapsed : Boolean = false;
    style showTitle : Boolean = false;
    style ratio : Double = −1;
}
node AttributeCompartment extends UMLCompartment
{
}
node OperationCompartment extends UMLCompartment
{
}
```

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this patent specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-based method of diagram interchange in graphical modeling of computer software, the method comprising:
modeling diagram definition for a given diagram type, the modeling defining valid diagram syntax for diagrams of the give diagram type; and
modeling diagram interchange in a manner (i) providing common diagram persistence and (ii) enabling interchange of diagram syntax,
said modeling diagram definition and modeling diagram interchange separate (a) diagram syntax for interchange purposes and (b) rules that govern valid composition of diagram syntax in a certain diagram type.

2. A computer-based method as claimed in claim 1 wherein the steps of modeling diagram interchange includes defining a small but extensible case of general purpose graphing elements usable by graphical modeling languages to persistent and interchange their diagram syntax.

3. A computer-based method as claimed in claim 2 wherein the modeling steps separate diagram syntax of the graphing elements from the rules that govern valid composition of the graphing elements for the given diagram type provided by the modeled diagram definition.

4. A computer-based method as claimed in claim 1 wherein the step of modeling diagram interchange includes separating abstract syntax of a subject model from the diagram data representing view of the subject model in a graphical modeling language.

5. A computer-based method as claimed in claim 1 wherein the step of modeling diagram definition includes generating diagram definition libraries that are referenced by respective diagrams and define corresponding valid syntaxes of the respective diagrams.

6. A computer-based method as claimed in claim 5 wherein said generating diagram definition libraries enables the step of modeling diagram interchange to be resilient to changes to a specific diagram syntax.

7. A computer-based method as claimed in claim 5 wherein the step of modeling diagram definitions further allows diagram definitions to not be restricted by metamodel sematics of model abstract syntax of a graphical modeling language.

8. A computer-based method as claimed in claim 5 wherein the diagram definition libraries enable generation of a modeling tool capable of creating and/or validating diagrams.

9. A computer-based method as claimed in claim 1 comprising the step of allowing the modeled diagram interchange to reference modeled diagram definition.

10. A computer system providing diagram interchange in graphical modeling of computer software; comprising:
a diagram definition module modeling diagram definition of a given diagram type, including defining valid diagram syntax for diagrams of the given diagram type; and
a diagram interchange member configured to model diagram interchange in a manner (i) providing common diagram persistence and (ii) enabling interchange of diagram syntax,
wherein the diagram definition module and the diagram interchange member separate (a) diagram syntax and (b) rules that govern valid composition of diagram syntax in a certain diagram type.

11. A computer system as claimed in claim 10 wherein the diagram interchange member further defines a set of general purpose graphing elements usable by graphical modeling languages to persist and interchange their diagram syntax.

12. A computer system as claimed in claim 11 wherein the diagram definition module and the diagram interchange member separate diagram syntax of the graphing elements from the rules that govern valid composition of the graphing elements provided by the diagram definition module.

13. A computer system as claimed in claim 10 wherein the diagram interchange member further separates abstract syntax of a subject model from diagram data representing view of the subject model.

14. A computer system as claimed in claim 10 wherein the diagram definition module further generates diagram definition libraries that are referenced by respective diagrams and define corresponding valid syntaxes of the respective diagrams.

15. A computer system as claimed in claim 14 wherein the generated diagram definition libraries enable the diagram interchange member to be resilient to changes to specific diagram syntax.

16. A computer system as claimed in claim 14 wherein the diagram definition module further allows diagram definitions to not be restricted by metamodel sematics of model abstract syntax of a graphical modeling language.

17. A computer system as claimed in claim 14 wherein the diagram definition libraries enable generation of a modeling tool capable of creating and/or validating diagrams.

18. A computer system as claimed in claim 10 wherein a modeled diagram interchange is allowed to reference diagram definition modeled by the diagram definition module.

19. A computer program product interchanging diagrams in a graphical modeling of computer software, the computer program product comprising:
a computer readable storage medium having computer readable program code embodied therewith, the computer readable program code comprising:
computer readable program code configured to model diagram definition of a given diagram type, including defining valid diagram syntax for diagrams of the given diagram type,
computer readable program code configured to define a set of general purpose graph elements and model diagram interchange in a manner (i) providing common diagram persistence and (ii) enabling interchange of diagram syntax,
wherein (a) diagram syntax of the general purpose graph elements and (b) rules that govern valid composition of graph elements provided in the model of diagram definition are maintained separately.

20. A computer program product as claimed in claim 19 further comprising computer readable program code configured to generate diagram definition libraries that are referenced by respective diagrams and define corresponding valid syntaxes of the respective diagrams,
wherein the diagram definition libraries enable generation of a modeling tool capable of creating and/or validating diagrams.
